(19) United States
(12) Patent Application Publication
(10) Pub. No.: US 2013/0297553 A1
(43) Pub. Date: Nov. 7, 2013

(54) METHOD AND APPARATUS FOR PREDICTING QUESTION ANSWERABILITY IN AN ONLINE CONSULTATION SYSTEM

(71) Applicant: Gann Bierner, Oakland, CA (US)

(72) Inventor: Gann Bierner, Oakland, CA (US)

(73) Assignee: Pearl.com LLC, San Francisco, CA (US)

(21) Appl. No.: 13/464,252

(22) Filed: May 4, 2012

(51) Int. Cl. G06N 5/02

(52) U.S. Cl. 706/52; 706/46

(57) ABSTRACT

Embodiments of the present invention further provide systems and methods for predicting the likelihood of a user posted the question to an online consultation system to not receive an answer based on the features extracted from the question.

### RELATED APPLICATIONS

The present application is related to U.S. patent application Ser. No. 12/854,838 filed on Aug. 11, 2010, U.S. patent application Ser. No. 12/854,836 filed on Aug. 11, 2010, U.S. patent application Ser. No. 12/854,849 filed on Aug. 11, 2010, and U.S. patent application Ser. No. 12/854,846 filed on Aug. 11, 2010, which are all incorporated herein by reference. The present application is also related to and incorporates by reference the below applications filed on the same day as the present invention, and entitled “Method and Apparatus For Automated Topic Extraction Used For The Creation and Promotion of New Categories In A Consultation System,” “Method and Apparatus for creation of web document titles optimized for search engines,” “Method and apparatus for identifying and eliciting missing question details in a consultation system,” “Method and apparatus for identifying customer service and duplicate questions in an online consultation system,” and “Method and apparatus for identifying similar questions in a consultation system,” by the same inventors, Gann Biermer and Edwin Cooper.

### FIELD OF INVENTION

The present application generally relates to the field of computer technology and, in specific exemplary embodiments, to methods and systems for automatically statistically predicting which questions posted to an online consultation system may go unanswered.

### BACKGROUND

The Internet has become the repository for all kinds of information and the first go to source for many people. The abundance of information available online has made finding accurate and reliable information difficult. Search engines help find information based on the content of the document. However, search engines cannot provide any guarantee on the reliability of the information. An online consultation system allowing users to submit questions on specific topics, for a fee and receive tailored answers from experts that have been verified to be knowledgeable in the particular topic. For the experts, the online consultation system provides a source of income, and a means to connect with and satisfy the needs of users that may otherwise not have any access to due to geographical or temporal distance. For the users, the online consultation system provides a source for reliable, customized and accurate information that is readily available to them at any time. However, in such an online consultation system, a non-trivial percentage of questions may go unanswered due to various factors. For example, the fee proposed by the user may not be commensurate with the difficulty of the question or the urgency of the answer. Unanswered questions result in dissatisfied users, lost income for the experts, and lower customer service satisfaction for the online consultation system.

### BRIEF DESCRIPTION OF DRAWINGS

The appended drawings are merely used to illustrate exemplary embodiments of the present invention and cannot be considered as limiting its scope.

FIG. 1 is a diagram of an exemplary environment in which embodiments of the present invention may be practiced.

FIG. 2 is a block diagram of an exemplary consultation system.

FIG. 3 is a block diagram of an exemplary web server.

FIG. 4 is a block diagram of an exemplary consultation analysis engine.

FIG. 5 is an exemplary block diagram of the text analysis module as applied to predicting question unanswerability.

FIG. 6 shows an exemplary flowchart of a method of predicting question unanswerability.

FIG. 7 shows a simplified block diagram of a digital device within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the present invention. In the following description, for purposes of explanation, munerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on quality control of experts, the embodiments are given merely for clarity and disclosure. Alternative embodiments may employ other systems and methods and are considered as being within the scope of the present invention.

Embodiments of the present invention provide systems and methods for automatically identifying missing details in questions and either automatically supplementing the details or soliciting the details from the user. In exemplary embodiments, the content of a question is analyzed and the missing information required for a satisfactory answer is supplemented using concept matching along with the use of an existing ontology.

Exemplary embodiments of the present invention further provide systems and methods for promoting a more efficient operation of an online question and answer site through automation of parts of the user and expert interactions.

In order to clarify the application of the present invention, an online web site and consultation system is used as an illustrative example. It would be apparent to one of skill in the art that the teachings of the present invention are not limited to the examples used herein and the systems and methods of the present invention have broader applications.

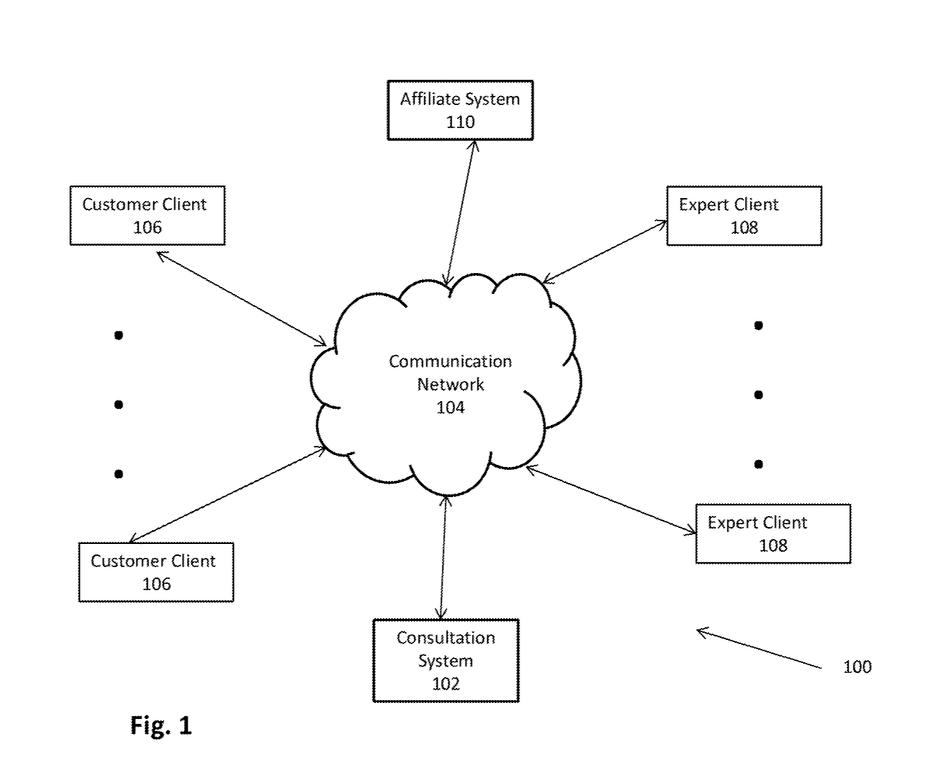

FIG. 1 shows an exemplary environment 100 of an online consultation website and system in which embodiments of the present invention may be practiced. The exemplary environment 100 comprises a consultation system 102 coupled via a communications network 104 to one or more users 106 and expert users 108. User 106, client, customer, customer client refers to a user of the consultation system 102. The communication network 104 may comprise one or more local area networks or wide area networks such as, for example, the Internet and telephone systems.

In exemplary embodiments, the consultation system 102 provides a forum where users may post or pose questions for which experts may provide answers. The consultation system 102 may provide the forum via a website. In some embodiments, at least portions of the forum (e.g., asking of questions or receiving of responses) may occur via the website, mobile phone, other websites, text messaging, telephone, video, VoIP, or other computer software applications. Because the consultation system 102 is network based e.g., Internet, the users using the consultation system 102 and experts providing answers may be geographically or temporally dispersed (e.g., may be located anywhere in the world in different time zones). As a result an expert may provide answers to a user thousands of miles away. Additionally, the consultation system 102 allows a large number of users and experts to exchange information at the same time and at any time.

By using embodiments of the present invention, a user posting a question may easily obtain a tailored or customized answer. Accordingly, one or more of the methodologies discussed herein may obviate a need for additional searching for answers, which may have the technical effect of reducing computing resources used by one or more devices within the system. Examples of such computing resources include, without limitation, processor cycles, network traffic, memory usage, storage space, and power consumption. In addition, the system allows the users to access reliable, customized information responsive to their issue without excessive searching of the Internet.

In various embodiments, a user may pose a question and one or more experts may provide answers. In various embodiments, the question may be matched with a category of experts, more specific set of experts, or even individual experts, sometimes on a rotating basis by user selection, a keyword based algorithm, a quality based algorithm (or score or rating), or other sorting mechanism that may include considerations such as, for example, likely location or time zone. A back-and-forth communication can occur.

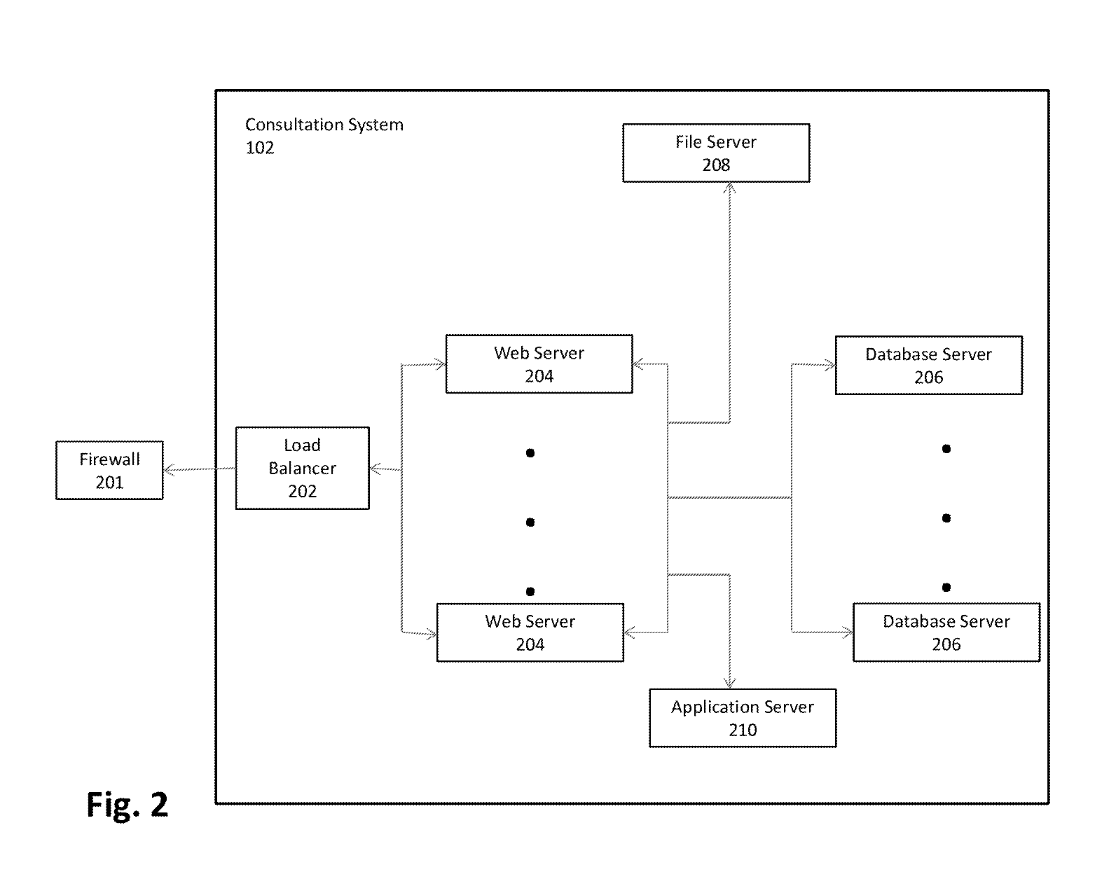

The user may accept an answer provided by one or more of the experts. In an alternative embodiment, the user may be deemed to have accepted the answer if the user does not reject it. By accepting the answer, the user validates the expert's answer which, in turn, may boost a score or rating associated with the expert. The user may also pay the expert for any accepted answers and may add a bonus. The user may also leave positive, neutral or negative feedback regarding the expert. More details regarding the consultation system 102 and its example functions will be discussed in connection with FIG. 2 below.

The exemplary user 106 is a device associated with a user accessing the consultation system 102 (e.g., via a website, telephone number, text message identifier, or other contact means associated with the consultation system 102). The user may comprise any individual who has, a question or is interested in finding answers to previously asked questions. The user 106 comprises a computing device (e.g., laptop, PDA, cellular phone) which has communication network access ability. For example, the user 106 may be a desktop computer initiating a browser for access to information on the communication network 104. The user 106 may also be associated with other devices for communication such as a telephone.

In exemplary embodiments, the expert user 108 is a device associated with an expert. The expert, by definition, may be any person that has, or entity whose members have, knowledge and appropriate qualifications relating to a particular subject matter. Some examples of expert subject matters include health (e.g., dental), medical (e.g., eye or pediatrics), legal (e.g., employment, intellectual property, or personal injury law), car, tax, computer, electronics, parenting, relationships, and so forth. Almost any subject matter that may be of interest to a user for which an expert has knowledge and appropriate qualifications may be contemplated. The expert may, but does not necessarily need to, have a license, certification or degree in a particular subject matter. For example, a car expert may have practical experience working the past 20 years at a car repair shop. In some embodiments, the expert may be a user (e.g., the expert posts a question).

The expert user 108 may comprise a computing device (e.g., laptop, PDA, cellular phone) which has communication network access ability. For example, the expert user 108 may be a desktop computer initiating a browser to exchange information via the communication network 104 with the consultation system 102. The expert user 108 may also be associated with other devices for communication such as a telephone.

In accordance with one embodiment, an affiliate system 110 may be provided in the exemplary environment 100. The affiliate system 110 may comprise an affiliate website or other portal which may include some of the components of the consultation system 102 or direct their users to the consultation system 102. For example, the affiliate system 110 may provide a website for a car group. A link or question box may be provided on the affiliate website to allow members of the car group to ask questions. The environment 100 of FIG. 1 is exemplary. Alternative embodiments may comprise any number of consultation systems 102, users 106, expert user 108, and affiliate systems 110 coupled together via any type of one or more communication networks 104, and still be within the scope of exemplary embodiments of the present invention. For example, while only one consultation system 102 is shown in the environment 100, alternative embodiments may comprise more than one consultation system 102. For instance, the consultation systems 102 may be regionally established.

Referring now to FIG. 2, the consultation system 102 is shown in more detail. In exemplary embodiments, the consultation system 102 may comprise a load balancer 202 which distributes work between two or more web servers 204 in order to optimize resource utilization and minimize response time. In some embodiments, a firewall 201 may be provided prior to the load balancer 202.

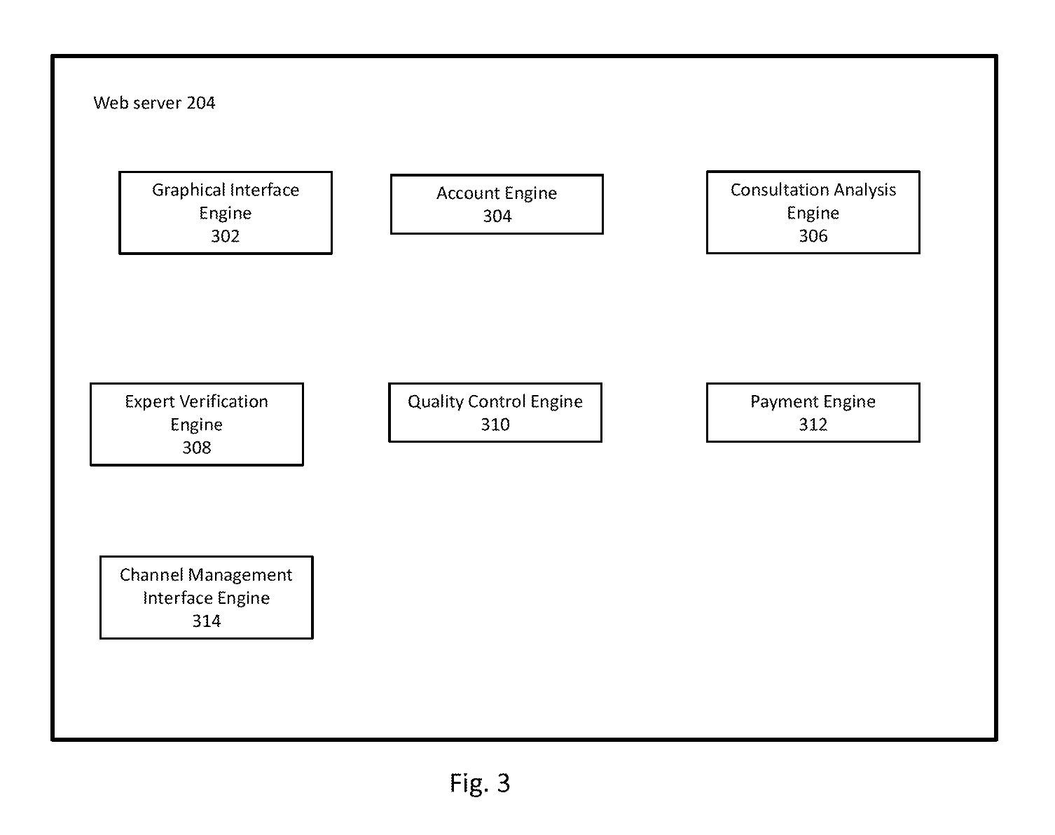

In exemplary embodiments, the web servers 204 are responsible for accepting communications from the users 106 (e.g., request or question) and expert user 108 (e.g., response) and serving the response including data content. In some instances, the request and response may be in HTTP or HTTPS which will result in HTML documents and linked objects (e.g., images) being provided to the user and expert users 106 and 108. The communications may include, for example, questions from the users, answers from the experts, acceptance from the user, payment information, account update information, videos, documents, photographs and voice. The web server 204 will be discussed in more detail in connection with FIG. 3.

Information used by the web server 204 to generate responses may be obtained from one or more database servers 206 and a file server 208. The exemplary database servers 206 store data or are coupled with data repositories storing data used by the consultation system 102. Examples of data include user information (e.g., username, e-mail address, credit card or other payment information), expect information (e.g., name, licenses, certifications, education and work history), previously asked questions and corresponding answers, and transaction information (e.g., payment, accepts, etc.). Essentially any data may be stored in, or accessed by, the database servers 206 including every user and expert interaction with the consultation system 102. Examples of interactions include how many questions the user has asked, which experts provided answers to the questions, and whether the user accepted the answers and paid the expert.

Content on the database servers 206 (or accessed by the database servers 206) may be organized into tables, and the tables may be linked together. For example, there may be one table for every question that has been previously asked, another table for posts (e.g., answers) to each question, and other tables for users and experts. In one example of the present invention, over 430 tables or spreadsheets are linked together.

In some embodiments, the database servers 206 may include logic to access the data stored in the tables. The logic may comprise a plurality of queries (e.g., thousands of queries) that are pre-written to access the data.

It should be noted that the functions of the database server 206 may be embodied within the web server 204. For example, the database servers 206 may be replaced by database storage devices or repositories located at the web servers 204. Therefore, any reference to the database server 206 and database storage device are interchangeable. Alternatively, some or all of the query logic may be embodied within the web server 204.

In exemplary embodiments, a plurality of database servers 206 is provided. The plurality of database servers 206 may share data and thus be identical (or close to being identical). By having identical database servers 206, load balancing and database backup may be provided.

The file server 208 stores or accesses files such as, for example, pictures, videos, voice files, PDF documents, Word documents, and PowerPoint presentations. When a particular file is requested or required in order to generate a response, the web server 204 may query the file server 208 for the file. Alternatively, the files may be stored at the database server 206 or other database storage devices, for example.

An application server 210 may also be provided in the consultation system 102. The application server 210 may provide applications and functions that are centralized to the consultation system 102. For example, the application server 210 may perform credit card processing with a bank that is coupled to the consultation system 102 via a network (e.g., the communication network 104).

It should be appreciated that in alternative embodiments, the consultation system 102 may include fewer or more components than shown in FIG. 2. For example, the consultation system 102 may comprise any number of web servers 204, database servers 206, file server 208, and application server 210. In another example, the file server 208 and application server 210 may be removed from the consultation system 102 and their functions performed by other servers in the consultation system 102. It will also be appreciated that the various servers may be embodied within each other and/or the consultation system 102 may be embodied within a single server. For example, the database server 206 may be embodied, as a storage device within the web server 204. It is also noted that the various servers of the consultation system 102 may be geographically dispersed within the exemplary environment 100.

Referring now to FIG. 3, one of the exemplary web servers 204 is shown in more detail. As discussed, the web servers 204 share in the workload in order to provide optimized performance. As such, each of the web servers 204 will include similar engines and modules. In the exemplary embodiment of FIG. 3, the web server 204 comprises a graphical interface engine 302, an accounts engine 304, a consultation analysis engine 306, an expert verification engine 308, a quality control engine 310, a payment engine 312, and a channel management engine 314 communicatively coupled together.

The exemplary graphical interface engine 302 generates graphical representations provided via the web page. In exemplary embodiments, the graphical interface engine 302 builds a page (e.g., made up of HTML, Javascript, CSS, sound, video, images, and other multimedia) that is presented to the user 106 or expert user 108. The page comprises static text (e.g., “Welcome to JustAnswer.”) and dynamic data (e.g., “Hello, hulagirl. You joined 3 months ago; have asked 17 questions; have accepted 12 answers.”). The dynamic data may be obtained, at least in part, from the database servers 206. In exemplary embodiments, the dynamic data may be retrieved using querying logic associated with the web server 204, the database server 206, or a combination of both, as discussed above.

The exemplary accounts engine 304 sets up, and maintains user accounts with the consultation system 102. Initially, the accounts engine 304 may provide a registration page via the graphical interface engine 302 for an individual (e.g., a user or expert) to fill out. The information collected via the registration page may be stored in the database server 206. Examples of information include user name, e-mail address, and billing and payment information. With respect to experts, the accounts engine may also collect information regarding the identity of the expert, information on credentials (e.g., license and certification numbers, degrees including university attended and years of attendance, employment history), and other data relating to the expert and the expert's application. Accounts for users may be automatically established and activated based on certain actions taken by the user, such as asking a question, agreeing to the terms of the consultation system, or providing payment. However, experts, in accordance with exemplary embodiments, proceed through an acceptance and verification process. If accepted, an expert account may then be established and activated by the accounts engine 304. The verification process will be discussed in more detail below.

The consultation analysis engine 306 manages answers in response to questions which have been posted to the consultation system 102. In exemplary embodiments, the consultation analysis engine 306 will receive questions along with indications of a category or subject matter each question is directed to from users. In various embodiments, a user may utilize a question page to enter a question which the user wants an expert to answer. As further described below, in many cases a user may initially find the consultation website after having first having entered a query in a search engine. Having found the online consultation site, the user may enter its question in the field for entering the question, including providing relevant information relating to the question (e.g. make and model of a car), as well as a selection box for selecting a subject matter expert under which the question should be posted to. In exemplary embodiments, other pages may be presented to the user before or after the question is submitted to experts, to obtain further data from or provide data to the user. In alternative embodiments, a “question details” page may be presented to users to solicit important information that could help the expert formulate a better answer to the user's question (e.g. make and model of a car in the car category, breed and age of a pet in the veterinary category, etc.). The question is also recorded into a corresponding table in the database server 206 (e.g., in a question table) and the user name of the user may also be entered into a corresponding table (e.g., user table). In some instances, the question may be outputted back to the user so that the user may confirm the question or edit the question if needed.

The user may also provide an amount that the user is willing to pay for an accepted answer, in some embodiments, as an amount selected by the user from different options offered to the user.

Once the question is posted on the consultation system 102, experts may provide answers in response to the question. The questions may be posted to a general or subject matter specific question list of recent questions that have been posted by users, a more specific group of experts, or certain experts one-at-a-time. In various embodiments, the question list may be sorted by certain types of information such as time of posting, the amount the user is willing to pay (e.g., value), the user's history of accepting previous answers, information regarding the subject matter of the question, or whether replies have been previously posted. Experts may periodically review the question list or other communications alerting them to questions to determine if there are any questions that the expert would like to answer. The expert may base their determination, in part, on the complexity of the question, their expertise, the amount the user is willing to pay for an answer, or the user's history of accepting previous answer, and whether the question is complete or missing details. Any of these factors may contribute to the reason why a question may go unanswered. In various embodiments, the user is able to place a deposit and name a price for an answer when posting the question or place the deposit after an expert has answered.

Should the expert decide to answer a question or request further information, an indication is provided to the user that there is an answer being offered or a request for further information, sometimes in the form of the answer or the request itself. The indication may also comprise an e-mail, text message, or pop-up notification to the user. In some cases, the user may place a deposit (e.g., the amount agreed upon to be paid if an answer is accepted) after being given the opportunity to view a profile of the expert offering the answer or a portion of the answer.

The answer is provided to the user. The answer may be displayed on a web page (e.g., an answer page), provided via a chat session, provided via a voice or text message, provided via video, provided by a software application, provided by other social media means (e.g., social networking sites where the user has a personal profile or page), or provided by telephone, mobile phone, or VoIP. Upon review of answers posted in response to a question, the user decides if any of the answers are acceptable to the user. The user may accept one or more answers that are posted. In exemplary embodiments, the user will pay the expert posting any accepted answers. If a particular answer is exceptional, in exemplary embodiments, the user may also provide a bonus to the expert providing the exceptional answer. When the user accepts an answer, monies from the deposits may also be paid to a host of the question and answers platform (e.g., host of the consultation system 102).

In various embodiments, different pricing options may be used for determining what a user may pay for getting an answer to a question or what an expert may be paid for providing an answer. In one embodiment, the pricing options may vary for each category or subcategory based on a variety of factors. These factors may include, for example, question length, time of day, day of week, location, or the ability of a user to pay. Additionally, discounts may be offered (e.g., two for one, ask one question get second for 50% off, free for pro bono users). In other embodiments, pricing may be selected and paid for by third-parties (e.g. employers of the users). In yet other embodiments, a user may subscribe to a subscription plan (e.g., unlimited questions each month for a particular fee or up to 10 questions each month for another fee). In other embodiments, a user or expert may be allowed to adjust the price prior to, during, or after the interaction between the user and the expert.

Acceptance and non-acceptance actions are tracked by the consultation analysis engine 306. For example, every user's accept-to-question ratio may be tracked and may be published to experts. Thus, if the ratio is low, experts may not answer the user's questions in the future. Furthermore, the user's question posting privileges may be suspended or the user may be removed from the consultation system 102 if the ratio is low or falls below a ratio threshold. The tracked acceptance and non-acceptance information is stored to the database server 206, and may be used to evaluate the quality of the experts as is discussed herein.

The user may also provide comments and feedback after viewing or accepting one or more answers. The feedback may be provided as, for example, a written comment, star rating, numerical scale rating, or any other form of rating. The feedback is stored to the database server 206, and may be used in the quality control processing. User satisfaction surveys may also be sent to collect data on the user's experience with the site, the expert, or the answer the user received.

According to some embodiments, if a user submitted question has been previously answered, a query of the database server 206 may be performed. The answers to previously asked questions may be stored in corresponding answer tables in the database server 206. These embodiments may occur when, for example, a user searches (e.g., using Google) for previous questions and answers. Multiple instances of access to the same questions and/or answers may be provided via a cache. Some or all users may also be allowed to search some or all previous questions or answers via a search tool on the website, or some or all previous questions or answers may be displayed to users at the discretion of the host, affiliate, or expert of the consultation system.

The exemplary expert verification engine 308 performs verification and acceptance of experts. In accordance with exemplary embodiments, the expert verification engine 308 verifies information provided by the potential experts (or experts) or receives verification data used to verify the experts' identities or credentials. The verification may occur prior to allowing the expert to join the consultation system 102. Alternatively, the verification may occur any tune after the expert has joined the consultation system 102. More than one verification may be performed for each expert, by requirement or by the expert's choice.

In exemplary embodiments, the quality control engine 310 evaluates experts in order to promote the high quality of experts in the consultation system 102. The evaluation may comprise scoring or ranking experts based on various elements. For example, the quality control engine 310 may access and review feedback associated with each expert, and score each expert accordingly. The quality control engine 310 may also review other factors which may increase or decrease an expert's score or ranking. The exemplary payment engine 312 manages pricing options and the payment of fees. In accordance with exemplary embodiments, users pay experts for accepted answers to their questions, for example, by way of payments per questions, payments per answers, payments per time frame, or payments on a subscription basis. In some instances, the user may provide a deposit in order to view answers prior to accepting the answers. The payment engine 312 may maintain a record of all these transactions. Additionally, the payment engine 312 may work with the application server 210, if provided, to process payments (e.g., credit card processing, PayPal processing).

The exemplary channel management engine 314 manages the creation of new channels in the consultation system 102. A new channel may comprise a new category or a new affiliate relationship on the consultation system 102. In some embodiments, the new category may be placed on a test site of the consultation system 102. However, questions may be posted to a main site of the consultation system 102 so that experts on the main site may also provide responses to the questions. Should the new category prove to be successful, the new category may then be moved to a main site of the consultation system 102. The new affiliate relationship results in the affiliate system 110 being linked to the consultation system 102.

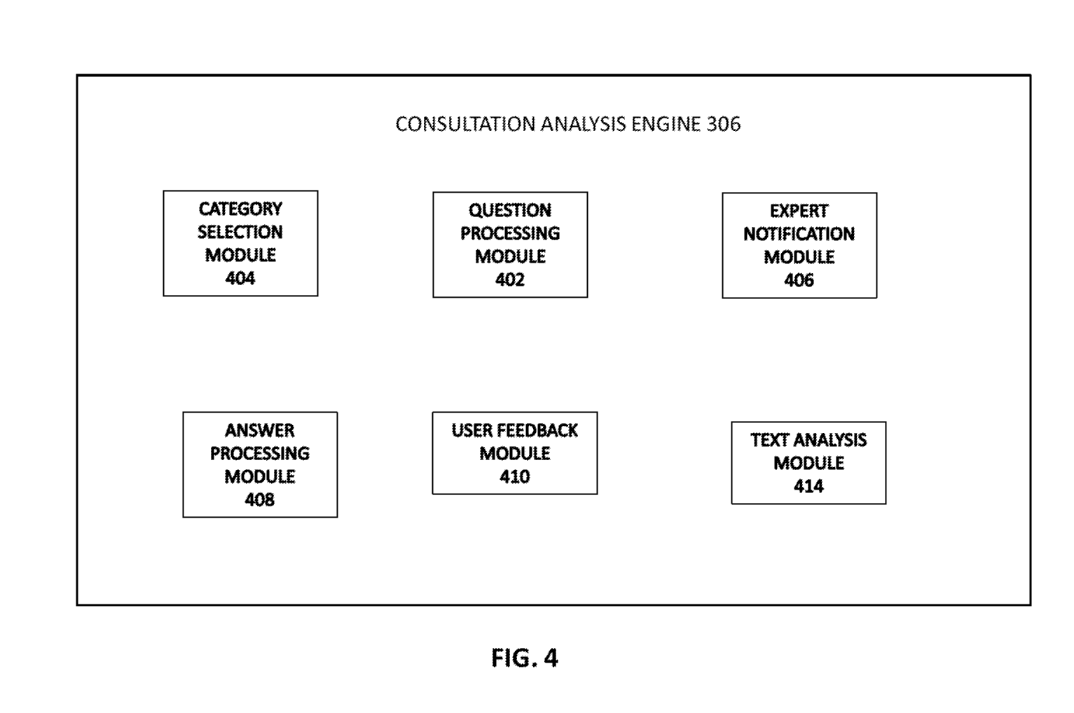

FIG. 4 is a block diagram of the consultation analysis engine 306. The consultation analysis engine 306 manages the questions and answers exchange between the users and experts through the online consultation system 102, as well as other users and experts interactions such as processing experts answers or managing user feedback of expert answers. In exemplary embodiments, the consultation analysis engine 306 comprises a category question processing module 402, a category selection module 404, an expert notification module 406, an answer processing module 408, a user feedback module 410, and text analysis module 414, communicatively coupled together. It is noted that some of the modules of the consultation analysis engine 306 may be embodied in other components of the consultation system 102. For example, the text analysis module 414 may be embodied in the channel management engine 314. Alternatively, the topic extraction module 414 and the answer processing module 408 may be both embodied in the question processing module 402.

The question processing module 402 receives questions submitted by users to the consultation system 102. As previously discussed, users may arrive at the consultation system 102′s website directly or indirectly. Users may reach the initial landing page through one of many affiliate websites. In most cases, regardless of how the user arrives at the online consultation system 102, the basic elements of the landing page may be similar, including a question box where the user may input and submit his or her question, as well as subsequent pages where the user can supplement the question with additional details. The question processing module 402 processes the submitted question from the user, including any metadata associated with the question. The question processing module may include additional features for analyzing and incorporating any details submitted through the “question details” page. In addition, the question processing module may filter the submitted question of any personal information such as phone numbers or address to protect the user's privacy.

The category selection module 404 operates to assign the question to an appropriate category. The appropriate category includes experts that have the expertise to answer the user's question. In one embodiment of the present invention, the category selection module may process the user's selection of a category to assign the question to that category. In alternative embodiments, an automated text analysis module such as the text analysis module 414 may process the question body and automatically assign a category the submitted question. In yet another embodiment, the category selection module may assign the question based on the affiliate channel through which the user is posting the question. For example, if an affiliate site is related to cars, questions generated from that affiliate website may be automatically directed to the car category.

The expert selection module 406 presents the posted user question to the right expert or group of experts. In one embodiment of the present invention, the expert selection may be based on input from the user. In an alternative embodiment, the expert selection is based on the question category. So, if a particular expert was not selected by the user, the expert selection module may present the question to all qualified expert within a given category.

In an exemplary embodiment of the present invention, an answer processing module 408 may process expert responses to posted questions, in the same manner the question processing module 402 processes user questions. In an alternative embodiment, the answers may be processed by the question processing module 402. In some exemplary embodiments of the present invention, the answer processing module 408 may send a notification to the user informing the user that his or her submitted question has been accepted by an expert or alternatively have been answered by an expert. The user may have to log back into the consultation system 102 to view and accept the posted answer and ask follow up questions if any.

In one exemplary embodiment of the present invention, a text analysis module 414 may be an independent module of the consultation analysis Engine 314. In an alternative embodiment, the text analysis module 414 may be embodied in the question processing module 402. In another embodiment, the text analysis module 414 may be embodied as part of the answer processing module 410. In yet another embodiment the text analysis module 414 may be incorporated in the channel management engine 306.

In various embodiments of the present invention, described in general terms, the text analysis module 414 receives as input texts from questions or answers, and applies various linguistic and/or statistical models to the text to process the content of the text input. A feature extraction component of the text analysis module 414 uses the processed text input along with a desired set of rules to extracts relevant features. So, the text extraction module 414 produces a desirable outcome (extracted features) based on the text input. In some implementation of the text analysis module 414, the given model may be perfected by allowing an iterative training process to tweak and optimize the model. Additionally, in alternative embodiments, various smoothing operations may be performed to for example change extracted feature weights or drop non relevant features all together.

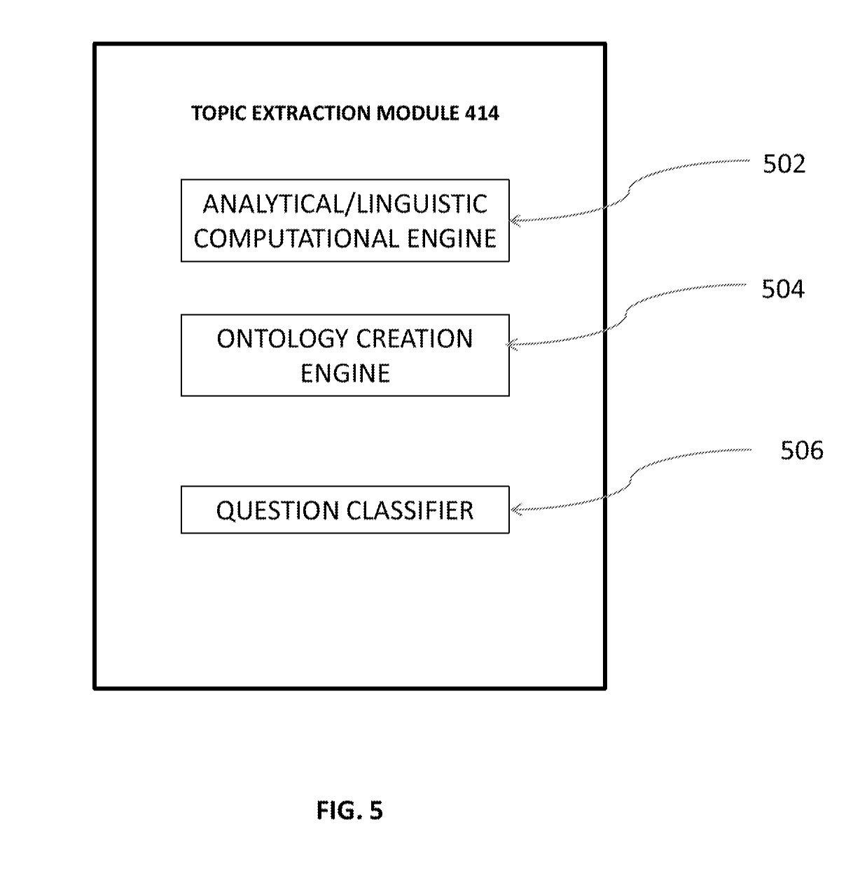

In the present invention, the text analysis module 414 is used to perform phrasal analysis of the body of a question, and identify and extract question details used to create a statistical model of the features of unanswered questions. The text analysis module 414 is further described below in FIG. 5.

FIG. 5 is an exemplary block diagram of the text analysis module 414 as applied to statistical prediction of question answerability. The exemplary consultation system 102 of the present invention may include hundreds of categories and subcategories of topics, where in each category and subcategory, many verified and vetted experts are available to answer user questions. A successful consultation system 102 may have thousands of users submit questions in each of the many topic categories, generating a large quantity of very relevant and specific content. Furthermore, the users may find the consultation system 102 either directly or through affiliate websites. In exemplary embodiments of the present invention, the consultation system 102 is a fee based consultation system, wherein the users offer a fee for receiving an answer to their questions submitted to the consultation system 102. Alternatively, the users may have a subscription based service allowing them to submit a certain number questions each month for a preset price.

The answerability of a user submitted question may be due multiple factors, each of which may be contributing to a total probability of the question not receiving an answer. Some of these factors may include question metadata related parameters such as the question length, category, and the fee the experts will receive when answering the question. In addition to these metadata factors, extracted features of the newly submitted question may be compared to the features extracted from previously submitted unanswered questions, where the comparison allows the identification of concepts or keywords included in the newly submitted question that may increase the question unanswerability. In alternative embodiments of the present invention, the probability associated with each concept or keyword found in the newly submitted question that is matched to a concept or keyword in the unanswerable question model is summed up to along with the probability associated with each meta data factor relevant to the newly submitted question to calculated a total probability value representing the likelihood of the newly submitted question receiving an answer.

Referring now to FIG. 5, the exemplary text analysis module 414 may include an analytical/computational linguistic engine 502 (hereinafter referred to as the linguistic engine), a statistical modeling engine 504 and a question classifier 506. The following definitions shall apply to the description in this application. A phrase is two or more adjacent in a sentence. A token is a word or other atomic element of a sentence.

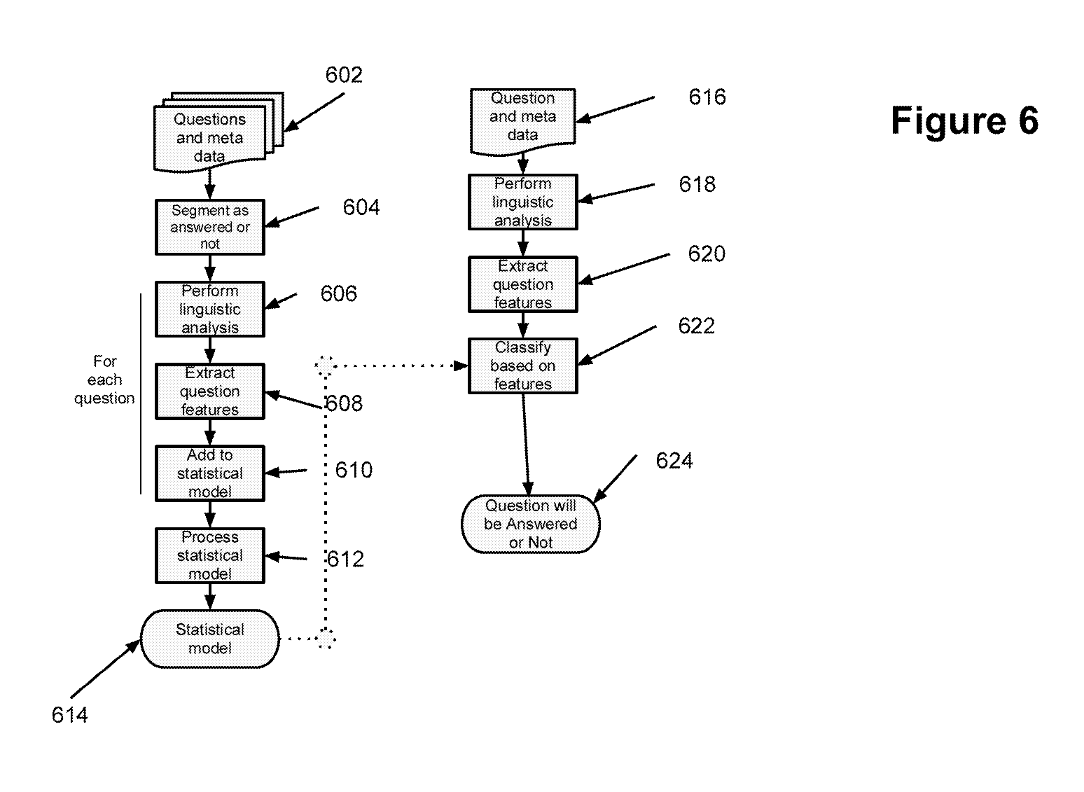

In an exemplary embodiment of the present invention, the linguistic engine 502 performs computational linguistics to parse the question under analysis into its individual components. The linguistic engine 502 may perform some or all of the following tasks: sentence detection, tokenization, phrase extraction, tagging of speech parts, and phrasal chunking. The linguistic engine 502 receives as input a given text, in this case the question posted by a user, and the linguistic engine identifies the various components comprising that text. For example, the linguistic engine 502 may breaks down the question into component parts of various levels of abstraction: words, phrases, parts of speech (e.g. noun, adjective, etc.), concepts, etc. The linguistic engine 502 can also tag parts of the speech used in phrasal chunking. The process flow of the various operations performed by the linguistic engine 502 will be further described in reference to FIG. 6, herein below.

Word segmentation (identifying a sentence's component words or concepts) can be performed both algorithmically and statistically. In one exemplary embodiment of the present invention, a statistical modeling approach may be used to improve accuracy of the word segmentation.

In an exemplary embodiment of the present invention, the statistical modeling engine 504 creates a statistical model of question features extracted from unanswered questions parsed and analyzed by the linguistic engine 502. The unanswered questions are tagged as unanswered once the question has remained unanswered longer than a given threshold. In one embodiment of the present invention, the threshold may be category specific, and may be adjusted based on the time of day the question submitted. For example, in a given category, any question that remains unanswered after 24 hours may be identified as unanswered. In a more popular category with larger pool of experts servicing the category, a question may be tagged as unanswered after four hours. In one embodiment of the present invention, the statistical modeling engine 504 counts the number of occurrences of various question features. In alternative embodiments of the present invention, the statistical modeling engine 504 may include filtering capabilities to further process the extracted question features. In an exemplary embodiment, a question classifier 506 may be used to compare the features extracted of the newly submitted question to the question features of the statistical model for unanswered questions. The comparison will tag a question as one with high probability of not receiving an answer if the newly submitted question features is similar enough to features of the statistical model. [This seems like a strange way to say this. The question features are applied to the model. The model does, indeed, perform some sort of operation on those features to determine the final result, but that's not necessarily a measure of similarity. In one embodiment, the output of the question classifier 506 may be a probability value for the chances of the newly submitted question to go unanswered. Therefore, in exemplary embodiments of the present invention, the user may be asked to modify various parameters about his or her submitted question so that the likelihood of receiving an answer increases. For example, if the question is deemed to be too complex or too long, the user may be increase the fee he or she is willing to pay for an answer. Alternatively, if the fee the user is willing to pay to receive an answer to the question is too low in general or too low based on the category of the question, or the length of the question, the question may go unanswered. In addition to factors increasing the likelihood of questions becoming unanswerable, extracted features of the newly submitted question may be compared to the features extracted from previously submitted unanswered questions, and the comparison allows to identify concepts or keywords included in the newly submitted question that may increase the question unanswerability. In alternative embodiments of the present invention, the probability associated with each concept or keyword found in the newly submitted question that is matched to a concept or keyword in the unanswerable question model is summed up to along with the probability associated with each meta data factor relevant to the newly submitted question to calculated a total probability value representing the likelihood of the newly submitted question receiving an answer.

FIG. 6 shows an exemplary flowchart of a method of statistically predicting question answerability. In operation 602, a database of questions residing on a database server 206 is accessed and individual questions and their corresponding metadata are retrieved. In exemplary embodiments of the present invention, the question meta data may include at least one of the question length, the question subject category, the fee the user is willing to pay for the answer to the newly submitted question.

In operation 604, the questions that have not received an answer by administrators or category moderators of the online consultation system 102 as are segmented in a separate group.

In an alternative embodiment, after a certain period of time has passed, the questions that remain unanswered are tagged as unanswered. The threshold for when to tag a question that has not received an answer may vary depending on the subject category and the traffic that category generates and the number of experts that service the category. For example, a question in the medical category that has not received an answer after one hour may be deemed as unanswerable. Alternatively, a question in the antique category, on the value of a given heirloom piece may be tagged as unanswered only after twenty four hours.

In operation 606, the text analysis module 414 performs linguistic analysis of each unanswered and unanswered question. The linguistic analysis is done for all questions so that the model can be trained to distinguish the features that render a question unanswerable from features that do not. As previously described, the text analysis may include breaking the question into its sentence components, and extracting individual tokens and phrases.

In operation 608, for each unanswered and answered question, question features identified in the linguistic analysis are extracted (tokens, stems, concepts and phrases) plus all the other linguistic data. In addition, other question parameters such as the sentence length may be recorded for each question. In exemplary embodiments, question metadata such as the price offered for the question, the question category and the time the question was submitted to the online consultation system 102 are recorded.

In operation 610, all the extracted question features including the relevant metadata are incorporated into a statistical model for unanswered questions. The statistical model may be created using the statistical modeling engine 504. In one embodiment of the present invention, the statistical modeling may involve counting the number occurrence of each feature for both answered and unanswered questions.

In an exemplary embodiment, in operation 612, the statistical model is processed where a probability value may be calculated and assigned to each extracted question feature being added into the model. In alternative embodiments, the models do not use probabilities. The statistical model of step 614 is used in the analysis and identification of questions that have a high statistical probability of going unanswered.

In operation 616, a new question submitted by a user along with its corresponding metadata is received. In operation 618, linguistic analysis is performed on the newly submitted question, including parsing up the question into its component tokens, concepts and phrases.

In operation 620, the question features identified in the linguistic analysis are extracted. These question features may include tokens, stems, phrases, and concepts. There are other, non-linguistic features that may be used such as price, category, length of question and combinations of them.

In operation 622, the question classifier engine 506 is used to compare the extracted question feature of the newly submitted question to the parameters of the statistical model.

Based on the comparison of the features extracted from the newly submitted question to the question parameters of the statistical model for unanswered questions, in operation 624, a determination is made on whether the newly submitted question has a high likelihood of going unanswered. In alternative embodiments, each feature is assigned a probability associated with it in the model. Combining the probabilities assigned to each feature with a prior probability yields a final combined probability value for the question. If the combined probability value is greater than a threshold, it would be a good predictor that the question has a high probability of not receiving an answer. A prior probability is the probability of a question being answered or unanswered without any knowledge about the question itself. The probabilities are combined using standard Bayesian techniques. In alternative embodiments of the present invention, the probability of a question going unanswered is a composite of multiple factors, each assigned to a given question parameter. For example, the question length feature may have one value, the price of the question may have another value and an extracted keyword may include yet another value. The overall probability of the question to go unanswered will be based on a composite value for all three parameters. Therefore, in exemplary embodiments, it may be easily determined that one or more factors are the main contributing cause of the high probability that the newly submitted question may go unanswered. For example, the newly submitted question may have a low offer price for the level of complexity of the question. In this, case, the user may be notified that his or her submitted question is unlikely to receive an answer due to the low price and the user may be asked to resubmit the question with a higher price. Alternatively, the online consultation system may provide a price range for the given question that may be more appropriate and increase the probability that the question will be answered.

Not every question parameter used in the formation of the statistical model is independent. To capture the fact that certain features or parameters are related to other parameters, the related features have to be linked together. In alternative embodiments of the present invention, related features of the unanswered questions are linked together in a couple of ways. One way is to simply create a new feature that is a combination of the original features. For example, the length parameter might originally just be length=0-10. To create a category that includes the length feature and the legal category, the features are defined as length=Legal: 0-10. Features can be combined in more fundamental ways. For example, with length and price, a ratio of price/length may be used as the feature. In exemplary embodiments of the present invention the particular classification model used is a “naive bayes” model requiring the interdependence of the component parameters be expressed in some fashion. In alternative embodiments, with different classification models, describing the interdependence of the various features may not be necessary. However, it would be apparent to one of skill in the art that alternative classification models may require other challenges in selecting and defining relevant features comprising the model.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner In certain exemplary embodiments, one or more computer systems (e.g., a standalone, user, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module or engine should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

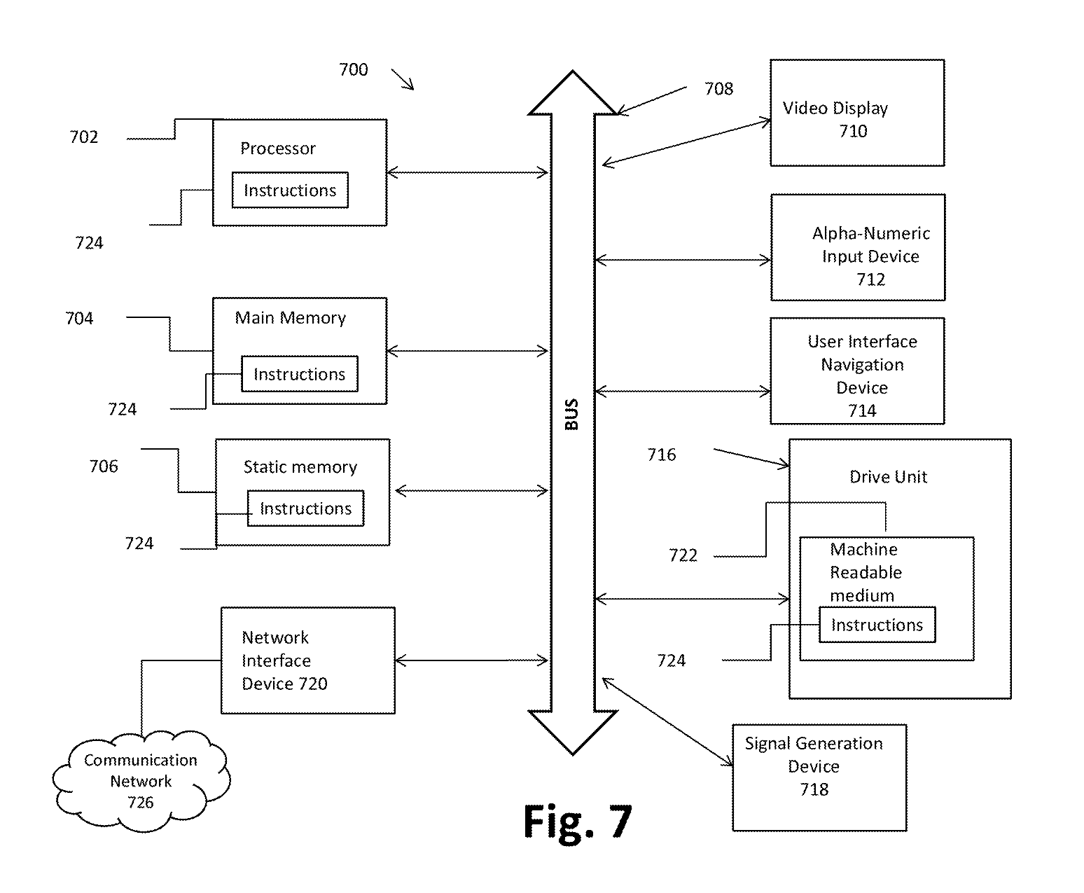

With reference to FIG. 7, an exemplary embodiment extends to a machine in the exemplary form of a computer system 700 within which instructions for causing the machine to perform any one or more of the methodologies discussed herein may be executed. In exemplary embodiments, the computer system 700 may be any one or more of the user 106, the expert user 108, affiliate system 110, and servers of the consultation system 102. In alternative exemplary embodiments, the machine operates as a standalone device or may be connected (e.g., networked) to other machines. In a networked deployment, the machine may operate in the capacity of a server or a user machine in server-user network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In exemplary embodiments, the computer system 700 also includes one or more of an alpha-numeric input device 99 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of instructions 724 and data structures (e.g., software instructions) embodying or used by any one or more of the methodologies or functions described herein.

The instructions 724 may also reside, completely or at least partially, within the main memory 704 or within the processor 702 during execution thereof by the computer system 700, the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The term “machine-readable medium” shall also be taken to include any non-transitory storage medium.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method of identifying an unanswerable question submitted to an online consultation website, the method comprising:
creating a model based on features extracted from unanswered questions;
extracting features from a newly submitted question by performing phrasal analysis;
comparing the extracted features of the newly submitted question to the features of the model; and
based on the comparison, predicting the question as an unaswerable question.

2. The method of claim 1, wherein at least one of the extracted features of the newly submitted question includes the question length.

3. The method of claim 1 wherein at least one of the extracted features of the newly submitted question includes the question category.

4. The method of claim 1 wherein at least one of the extracted features of the newly submitted question includes the category.

5. The method of claim 1 wherein at least one of the extracted features of the newly submitted question includes a fee offered by the user.

6. The method of claim 1 wherein at least one of the extracted features of the newly submitted question includes a combination of the fee and the length.

7. The method of claim 1 wherein the extracted features of the newly submitted question includes the combination of the fee and the category.

8. The method of claim 1 wherein the extracted features of the newly submitted question includes the combination of the length and the category

9. The method of claim 1 wherein the predicting of question answerability is based on adding probabilities of each feature extracted from the newly submitted question.

10. An apparatus for identifying an unanswerable question submitted to an online consultation website, the apparatus comprising:
a model creation engine for creating a model based on features extracted from a unanswered questions;
a phrasal analysis engine for performing phrasal analysis of a newly submitted question and extracting features from the newly submitted question;
a comparison engine for comparing the extracted features of the newly submitted question to the features of the model; and
a probability calculator for calculating a likelihood of the newly submitted questions going unanswered.

11. A non-transitory machine-readable storage medium having embodied thereon instructions which when executed by at least one processor, causes a machine to perform operations comprising:
creating a model based on features extracted from unanswered questions;
extracting features from a newly submitted question by performing phrasal analysis;
comparing the extracted features of the newly submitted question to the features of the model; and
based on the comparison, predicting the question as an unaswerable question.
